(19) United States
(12) Patent Application Publication
(10) Pub. No.: US 2012/0160071 A1
(43) Pub. Date: Jun. 28, 2012

(54) SAW MACHINE FENCE ADJUSTMENT MECHANISM

(75) Inventor: Jung-Huo CHEN, Taichung (TW)

(73) Assignee: REXON INDUSTRIAL CORP., LTD., Taichung (TW)

(21) Appl. No.: 13/328,124

(22) Filed: Dec. 16, 2011

(30) Foreign Application Priority Data
Dec. 28, 2010 (TW) 099146296

(51) Int. Cl. B26D 7/01

(52) U.S. Cl. 83/468.2

(57) ABSTRACT

A saw machine fence adjustment mechanism installed on a base member of a worktable, including a fence body, a pivot shaft mounted on the fence body, a spanner coupled to the pivot shaft, a spring member positioned between the spanner and the fence body and a locking device on the pivot shaft adapted for locking the fence body. To adjust the position of the fence body, the spanner operated to rotate the pivot shaft to move the locking device away from the base member for allowing adjustment of the position of the fence body. After adjustment of the position of the fence body, the spanner is released to allow the spring member to bias the pivot shaft to its former angular position and to force the locking device into engagement with the base member to provide quick adjustment of the position of the fence body to provide sufficient support.

This application claims, under 35 U.S.C. §119, priority to Taiwanese Application No. 099146296, filed Dec. 28, 2010, which application is hereby incorporated by reference in its entirety, inclusive of the specification, claims, and drawings.

### FIELD OF THE INVENTION

The present invention relates to saw machines and more specifically, to a fence adjustment mechanism for saw machines.

### BACKGROUND

A conventional saw machine, as indicated in Taiwan Patent No. M302455, includes a fence for supporting the workpiece, including an adjustment mechanism. The fence adjustment mechanism of the saw machine is mounted to a base member that is installed on a worktable for supporting the workpiece. The fence adjustment mechanism includes a fence body, and a lock screw. The fence body is movable relative to the base member between a normal-cutting supporting position and a tilt-cutting supporting position. The lock screw is mounted to the fence body for selectively engaging the base member.

When a cutter unit of the saw machine is operated for vertically cutting the workpiece, the fence body is maintained in the normal-cutting supporting position, i.e., the fence body is substantially disposed at the top side of the base member adjacent to the cutter unit so that the fence body and the base member can support the workpiece for cutting. When the workpiece is to be cut with an angled cut, the lock screw is loosened and then the fence body is moved relative to the base member in a direction away from the cutter unit to the tilt-cutting supporting position where the fence body does not interfere with the tilt cutting operation of the cutter unit. Thereafter, the lock screw is fastened to lock the fence body to the base member in the tilt-cutting supporting position.

According to the aforesaid prior art design, the user must first loosen the lock screw to unfasten the lock screw and then tighten the lock screw to refasten the lock screw during every fence position adjustment operation. This adjustment method is inconvenient and time consuming.

FIGS. 1 and 2 illustrate another design of a fence adjustment mechanism 1 according to the prior art. According to this design, the fence body 11 of the fence adjustment mechanism 1 is pivotally mounted to a base member 100 that is installed on a worktable 200. The fence body 11 is adjustable between a normal-cutting supporting position and a tilt-cutting supporting position. In order to adjust the fence body 11 from the normal-cutting supporting position to the tilt-cutting supporting position, the fence body 11 is rotated outwardly through an angle of 180-degrees. Thus, in this position, the fence body 11 does not interfere with the tilt cutting operation of the cutter unit 300.

However, when the fence body 11 is moved to the tilt-cutting supporting position, the fence body is spaced far away from the cutter unit 300. This design does not allow multi-step adjustment. If the workpiece is not wide enough, the fence body 11 will be unable to support the workpiece in the tilt-cutting position. Further, as the height of the base member 100 is limited, the workpiece may not get sufficient support in the tilt-cutting position. Such a configuration thus results in a dangerous situation when—the workpiece is cut under an insufficient support condition.

Therefore, there is a strong demand for a fence adjustment mechanism for saw machines, which allows quick adjustment of the position of the fence body to provide sufficient support to the workpiece, regardless of the cutting position.

### SUMMARY

The present disclosure thus provides a saw machine fence adjustment mechanism, which allows quick adjustment of the position of the fence body to provide sufficient support to the workpiece, regardless of the cutting position.

To achieve this and other objects, a saw machine according to an embodiment of the present disclosure includes a fence adjustment mechanism installed on a base member which is disposed on a worktable of a saw machine for supporting a workpiece. The base member includes a bearing portion. The saw machine fence adjustment mechanism includes a fence body for supporting the workpiece and to correspond to a cutting angle of the cutter unit of the saw machine. The fence body has a locked configuration and an unlocked configuration, and is movable relative to the base member when in the unlocked configuration. A pivot shaft is pivotally mounted to the fence body, a spanner is concentrically arranged on the pivot shaft, and a spring member has two ends respectively abutting against the spanner and the fence body. A locking device is installed at a lower end of the pivot shaft corresponding to and cooperating with the bearing portion of the base member. The locking device is rotatable with rotation of the pivot shaft. When the fence body is in the locked configuration, the locking device is abutting against the base member. When the fence body is in the unlocked configuration, the locking device is disengaged from the base member for allowing movement of the fence body relative to the base member.

One effect of the present invention is that: by way of operating the spanner to rotate the pivot shaft and the locking device, the locking device is driven, such that the locking device is disengaged from the bearing portion of the worktable for allowing the position of the fence body to be adjusted. When the spanner is released, a spring force of the spring member drives the spanner to rotate the pivot shaft such that the locking device is driven by the pivot shaft to return to the locking position. Further, by adjusting the position of the fence body relative to the base member, the fence body and the base member provide a sufficient support to the workpiece.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view illustrating a saw machine fence adjustment mechanism according to the prior art.

FIG. 2 corresponds to FIG. 1, illustrating the position of the fence body adjusted to the normal-cutting position.

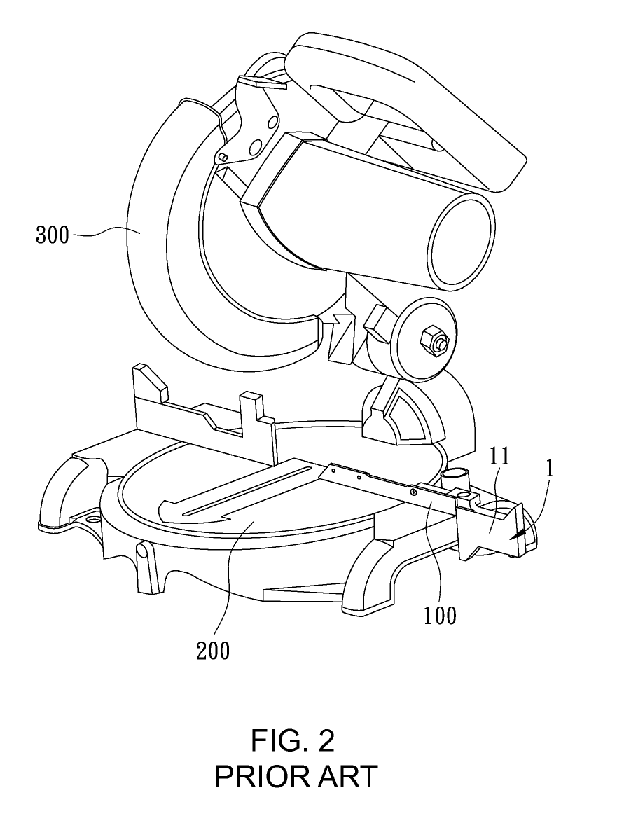

FIG. 3 is a front view of a saw machine fence adjustment mechanism in accordance with an embodiment of the present disclosure.

FIG. 4 is a rear side view of the embodiment shown in FIG. 3, illustrating the relationship of the fence body, the pivot shaft and the spanner of the saw machine fence adjustment mechanism.

FIG. 5 is a top view of the embodiment shown in FIG. 3, illustrating the relationship of the pivot shaft, the spanner and the spring member of the saw machine fence adjustment mechanism.

FIG. 6 is a partial sectional top view of the embodiment shown in FIG. 3, illustrating the large diameter portion of the locking device engaged with the base member.

FIG. 7 is a partial sectional top view of the embodiment shown in FIG. 3, illustrating the small diameter portion of the locking device moved facing toward the base member.

FIG. 8 is a front view of the embodiment shown in FIG. 3, illustrating the position of the fence body adjusted to the tilt-cutting position.

### DETAILED DESCRIPTION

Before providing a detailed description of one preferred embodiment of the present invention, it is to be understood that like reference numbers through out the drawings denote like component parts.

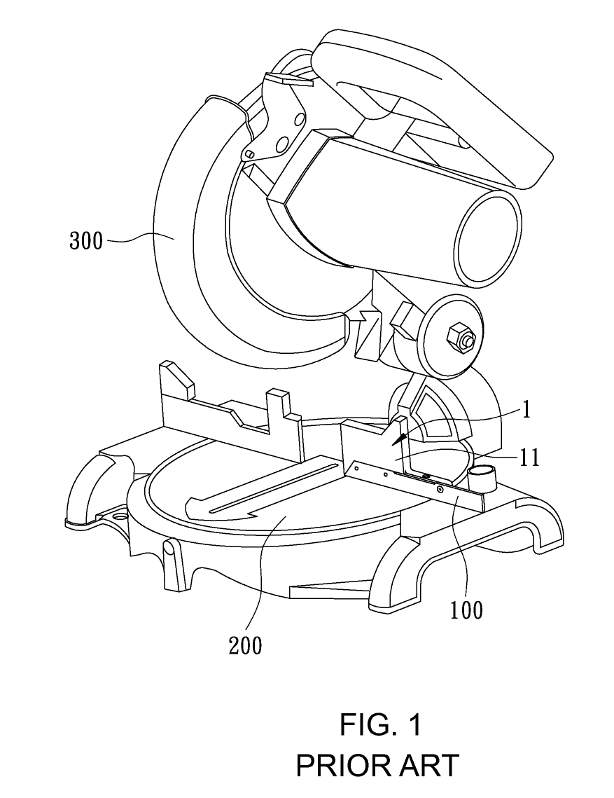

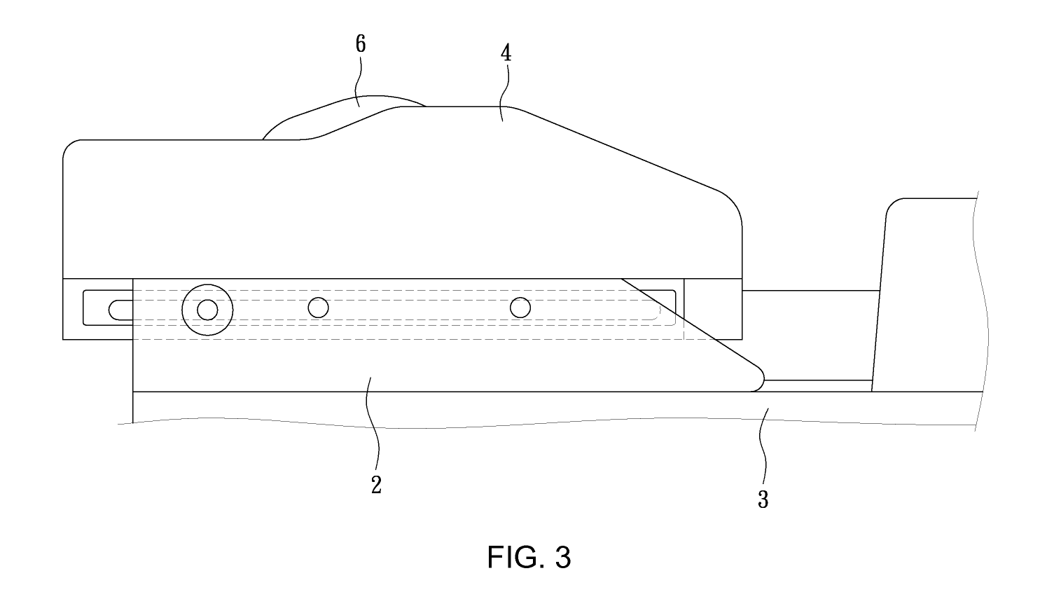

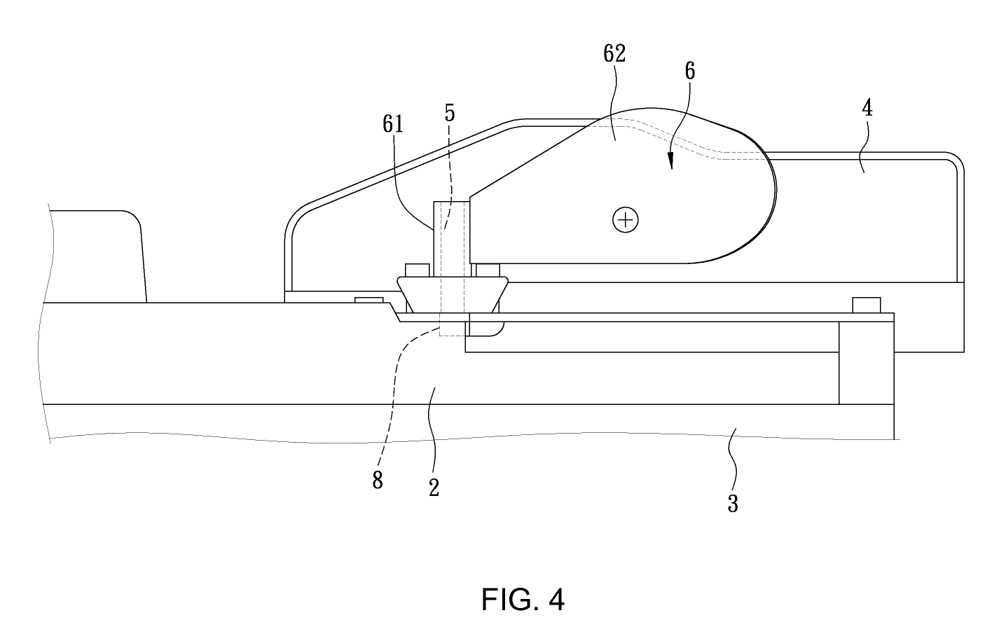

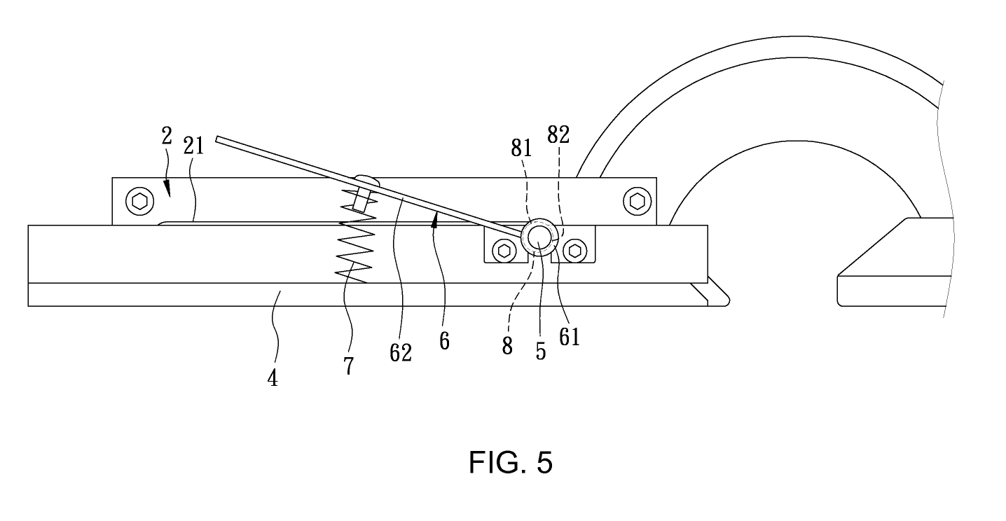

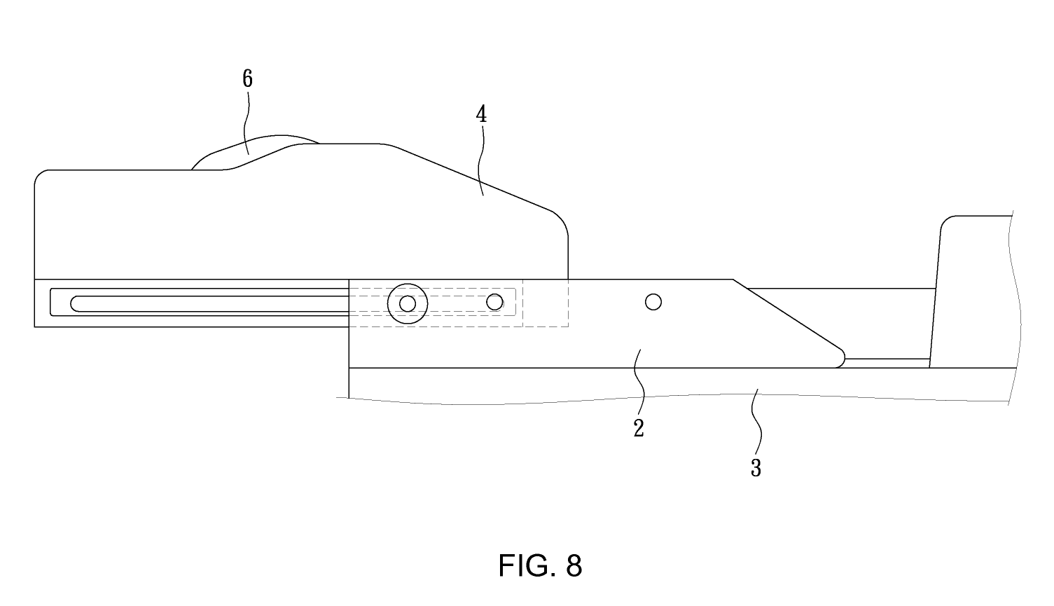

Referring to FIGS. 3, 4, 5 and 8, a saw machine fence adjustment mechanism is shown installed on a base member 2. The base member 2 is mounted to a worktable 3 to support a workpiece, and includes a recessed bearing portion 21. Further, the worktable 3 is equipped with a cutter unit (see also FIG. 1). The saw machine fence adjustment mechanism includes a fence body 4, a pivot shaft 5, a spanner 6, a spring member 7, and a locking device 8.

The fence body 4 and the base member 2 are adapted for supporting the workpiece in correspondence with a cutting angle of the cutter unit of the saw machine. The fence body has a locked configuration and an unlocked configuration, and is movable relative to the base member when in the unlocked configuration.

The pivot shaft 5 is pivotally mounted to the fence body 4 in a perpendicular manner relative to the worktable 3, i.e., the pivot shaft 5 is perpendicularly disposed at the top side of the base member 2 and the worktable 3.

The spanner 6 is connected to the pivot shaft 5. The spanner 6 includes a coupling portion 61 that is concentrically arranged on the pivot shaft 5 and a pressure plate 62 which is connected with and extends away from the coupling portion 61. A first end of the spring member 7 abuts against the pressure plate 62.

The spring member 7 in this embodiment is a compression spring. The spring member 7 has two opposite ends, a first end and a second end, respectively abutting against the pressure plate 62 of the spanner 6 and the fence body 4 to constantly impart a spring force to the pressure plate 62 of the spanner 6 such that the pressure plate 62 is constantly biased to be oriented away from the fence body 4.

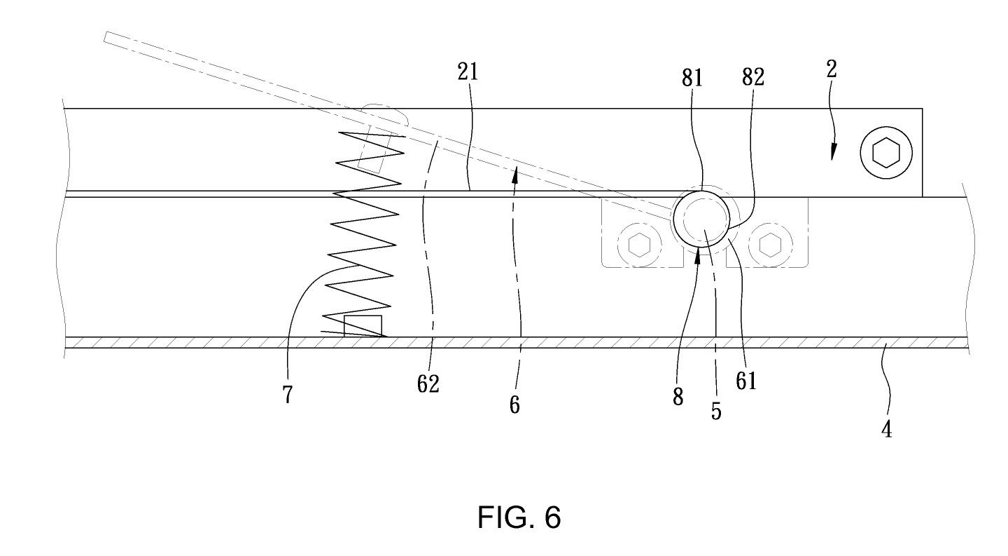

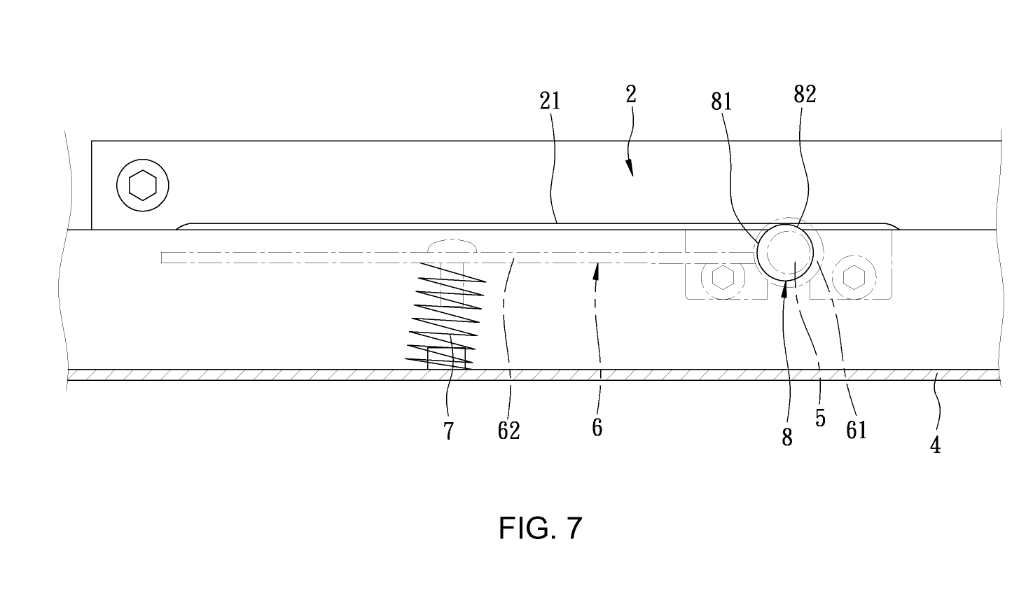

The locking device 8 is installed at a lower end of the pivot shaft 5 corresponding to and cooperating with the recessed bearing portion 21 of the worktable 2. The locking device 8 is rotatable with rotation the pivot shaft 5. In this embodiment, the locking device 8 is an eccentric wheel which has a large diameter portion 81 and a small diameter portion 82. When the spanner 6 is moved by a user against the biasing force provided by the spring member 7, the pivot shaft 5 is driven to rotate the locking device 8, such that either the small diameter portion 82 or the large diameter portion 81 is oriented toward the recessed bearing portion 21 of the worktable 2. As a result of the difference in size between the large diameter portion 81 and the small diameter portion 82, the locking device 8 is frictionally engaged with the recessed bearing portion 21 to provide the locked configuration (FIG. 6) or the locking device 8 is disengaged from the recessed bearing portion 21 to provide the unlocked configuration (FIG. 7) so that the fence body 4 can be moved relative to the base member 2.

Referring also to FIG. 7, to adjust the position of the fence body 4, i.e., when wishing to unlock the fence body 4, a user can simply impart a pressure to the pressure plate 62 of the spanner 6 to compress the spring member 7, driving the pivot shaft 5 to move the locking device 8, such that the large diameter portion 81 of the locking device 8 is driven to disengage from the recessed bearing portion 21 of the worktable 2 and the small diameter portion 82 is driven and orientated toward the recessed bearing portion 21 of the worktable 2 to face the recessed bearing portion 21, and therefore the fence body 4 is unlocked from the base member 2 and can be adjusted to the desired position relative to the base member 2. The length of the recessed bearing portion 21 provides a specified length of adjustment, and the fence body 4 can be adjusted to any position along the length of the recessed bearing portion 21.

After adjustment of the fence body 4 to the desired position, the user can release the pressure from the pressure plate 62 of the spanner 6 to release the spring member 7, enabling the spanner 6 to be biased by the spring force of the spring member 7 in a reversed direction to drive the large diameter portion 81 of the locking device 8 toward the recessed bearing portion 21 of the worktable 2 again, i.e., the spring force of the spring member 7 constantly drives the large diameter portion 81 of the locking device 8 toward the recessed bearing portion 21 of the worktable 2.

In conclusion, when pressure is applied to the spanner 6 to rotate the pivot shaft 5 and the locking device 8, the locking device 8 is driven to rotatably move the small diameter portion 82 to orient facing toward the recessed bearing portion 21 of the worktable 2, allowing adjustment of the position of the fence body 4. When the spanner 6 is released (i.e. the pressure imparted on the spanner 6 is released), the spring force of the spring member 7 immediately recovers, such that the pivot shaft 5 moves the locking device 8, driving the large diameter portion 81 of the locking device 8 to engage the recessed bearing portion 21 of the worktable 2. Thus, operating the pressure plate 62 of the spanner 6 allows the fence body 4 to be changed from the locked configuration to the unlocked configuration in order move the fence body 4 relative to the base member 2, thus allowing quick adjustment of the position of the fence body 4 relative to the base member 2. Further, by means of adjusting the position of the fence body 4 relative to the base member 2 to any desired position along the length of the recessed bearing portion 21, the fence body 4 and the base member 2 provide a sufficient support to the workpiece in numerous positions of the fence body 4.

Although a particular embodiment of the invention has been described in detail for purposes of illustration, various modifications and enhancements may be made without departing from the spirit and scope of the invention. Accordingly, the invention is not to be limited except as by the appended claims

What is claimed is:

1. A saw machine fence adjustment mechanism installed on a base member disposed on a worktable of a saw machine for supporting a workpiece, said base member comprising a bearing portion, said saw machine fence adjustment mechanism comprising:
a fence body for supporting the workpiece to match with a cutting angle of a cutter unit of said saw machine, said fence body having a locked configuration and an unlocked configuration;
a pivot shaft pivotally mounted to said fence body;
a spanner connected to said pivot shaft;
a spring member having respectively first end abutting against said spanner and a second end abutting against said fence body; and
a locking device installed at a lower end said pivot shaft and corresponding to and cooperating with said bearing portion, said locking device being rotatable with said pivot shaft;
wherein:
when said fence body is in said locked configuration, said locking device engages said base member; and
when said fence body is in said unlocked configuration, said locking device is disengaged from said base member for allowing movement of said fence body relative to said base member.

2. The saw machine fence adjustment mechanism according to claim 1, wherein said locking device is an eccentric wheel, said eccentric wheel having a large diameter portion and a small diameter portion; said bearing portion of said base member is a recessed bearing portion;
wherein:
when said fence body is in said locked configuration, said large diameter portion abuts against said recessed bearing portion; and
when said fence body is in said unlocked configuration, said small diameter portion of said locking device is oriented facing toward said recessed bearing portion of said base member.

3. The saw machine fence adjustment mechanism according to claim 2, wherein said spanner comprises a coupling portion concentrically arranged on said pivot shaft and a pressure plate connected with said coupling portion, and the first end of the spring member abuts against the pressure plate.

4. The saw machine fence adjustment mechanism according to claim 2, wherein said spring member is a compression spring.

5. The saw machine fence adjustment mechanism according to claim 2, wherein said spring member constantly imparts a spring force to said spanner for biasing said large diameter portion of said locking device to engage said base member.

6. The saw machine fence adjustment mechanism according to claim 2, wherein said pivot shaft is perpendicular to said worktable.
